(19) United States
(12) Patent Application Publication
(10) Pub. No.: US 2018/0297285 A1
(43) Pub. Date: Oct. 18, 2018

(54) Dynamic Separation Systems and Methods for 3D Printers

(71) Applicant: 3D Currax Solutions Inc., Kelowa (CA)

(72) Inventors: Dylan James SHEPPARD, Peachland (CA); Nicholas MARTIN, Kelowna (CA); Barry Alan MILLS, Kelowna (CA)

(73) Assignee: 3D Currax Solutions Inc., Kelowna (CA)

(21) Appl. No.: 15/951,648

(22) Filed: Apr. 12, 2018

Related U.S. Application Data
(60) Provisional application No. 62/485,190, filed on Apr. 13, 2017.

(51) Int. Cl. B29C 64/379; B33Y 40/00; B33Y 30/00; B29C 64/255; B29C 64/393; B33Y 50/02

(52) U.S. Cl. CPC B29C 64/379; B33Y 40/00; B33Y 50/02; B29C 64/255; B29C 64/393; B33Y 30/00

(57) ABSTRACT

An apparatus for releasing a 3D stereolithographic printed layer from a vat of resin includes a vat having a release layer and configured to contain solidifiable resin; and one or more release mechanisms including a build plate which is configured to adjust the position of the object being printed with respect to a release layer. In order to separate the release layer from solidified resin in contact with the release layer, the apparatus may control the build plate based on a force measurement and/or activate secondary release mechanisms such as vibrating the release layer.

### CROSS-REFERENCE TO RELATED APPLICATIONS

This application claims priority to U.S. Provisional Application Ser. No. 62/485,190 filed on Apr. 13, 2017, the entire disclosure of which is incorporated herein by reference.

### FIELD OF THE INVENTION

The invention relates to 3D printing and, in particular, to photo-solidification printers.

### BACKGROUND

Photo-solidification (may also be known as Stereolithography, Photo-Solidification, Solid Free-Form Fabrication, Solid Imaging, Rapid Prototyping, Resin Printing, and 3D printing) is a form of additive manufacturing technology used for creating models, prototypes, patterns, and production parts in a layer by layer fashion using photopolymerization, a process by which light causes chains of molecules to link together, forming polymers.

One type of stereolithography is an additive manufacturing process that works by focusing an energy source on to a vat of photopolymer resin. With the help of computer aided manufacturing or computer aided design software (CAM/CAD), energy source is used to draw a pre-programmed design or shape on to the surface of the photopolymer vat. Because photopolymers are photosensitive, the resin is solidified and forms a single layer of the desired 3D object. This process is repeated for each layer of the design until the 3D object is complete.

Another type of stereolithography uses ‘bottom-up’ manufacturing. Such systems have an elevator platform which descends to a distance equal to the thickness of a single layer of the design (e.g. 0.05 mm to 0.15 mm) into the liquid photopolymer. Then portions of the liquid photopolymer between the object or platform and the vat base are cured to cause the liquid to solidify. A complete 3D object can be formed using this process.

An issue with the ‘bottom-up’ manufacturing is that when the liquid photopolymer is cured it adheres not only with the previously cured layer, but also to the vat itself. Therefore, there is a need for a system which allows the newly cured layer to be separated from the vat.

### SUMMARY

In accordance with the present disclosure, there is provided a release assembly apparatus for a 3D printer comprising:

a vat configured to contain solidifiable resin and having a release layer, the release layer being configured to transmit solidification energy from a solidification energy source into the vat of solidifiable resin to solidify at least a portion of the solidifiable resin in contact with the release layer;

one or more release mechanisms including a build plate configured to control the position of the object being printed with respect to the release layer;

a force sensor configured to measure the force applied to the object being printed as it is moving away from the release layer to release the object being printed;

wherein the apparatus is configured to control the one or more release mechanisms based on the measured force.

Controlling the release mechanisms may comprise one or more of: starting the release mechanism; stopping the release mechanism; changing the intensity of the release mechanism. A release mechanism may be any mechanism which facilitates or causes release of the object being printed from the release layer. Release mechanisms may include one or more of: moving the build plate; and vibrating the release layer.

The apparatus may be configured to control the motion of the build plate with respect to the release layer based on the measured force. The apparatus may be configured to take into account the weight of the object being printed. For example, if the force is measured at the build plate, the apparatus may deduct the weight of the object being printed (e.g. based on the volume of the object being printed and the density of the cured resin) to determine the force applied to the release layer by the movement of the object. The force may be measured by one or more force sensors at a range of locations within the apparatus (e.g. at the build plate, at the release layer). From these measurements, the force between the release layer and the object being printed may be determined.

The apparatus may be configured to control the motion of the build plate with respect to the release layer based on absolute value of the measured force.

The apparatus may be configured to slow down separation speed if the force is above a separation-speed threshold force value.

The apparatus may be configured to increase separation speed if the force is below a low threshold value.

The apparatus may be configured to control the motion of the build plate with respect to the release layer based on the rate of change of the measured force.

The apparatus may be configured to stop separating the build plate from the release layer in response to detecting a decrease in measured force at a rate higher than a predetermined force-drop rate threshold. The force-drop rate threshold may be 97% decrease in force per second. Other thresholds may be used. For example, The force-drop rate threshold may be 80% decrease in force per second, or 50% decrease in force per second.

The apparatus may be configured to stop separating the build plate from the release layer in response to detecting a decrease in measured force to below a release threshold value.

The apparatus may be configured to control a secondary release mechanism based on the measured force.

The apparatus may be configured to initiate the secondary release mechanism in response to measuring a force above a secondary-release threshold force value.

The apparatus may be configured to control the one or more release mechanisms based on the measured force and the area cured in the last curing step.

The apparatus may be configured to control the one or more release mechanisms based on the measured force and the shape of the last printed layer.

The one or more release mechanisms may include a vibration actuator connected to the release layer, wherein the apparatus is configured to vibrate the release layer using the vibration actuator to effect release of the solidifiable resin from the release layer.

According to a further aspect, there is provided a method for controlling the release of an object being printed from a 3D printer, the method comprising:

curing a layer of resin between an object being printed and a release layer, the release layer being configured to transmit solidification energy from a solidification energy source into the vat of solidifiable resin to solidify at least a portion of the solidifiable resin in contact with the release layer;

moving the object away from the release layer to release the object being printed;

measuring the force applied to the object being printed as it is moving away from the release layer;

controlling one or more release mechanisms based on the measured force.

According to a further aspect of the present disclosure, there is provided an release assembly apparatus for making a three-dimensional object by photo-solidification, comprising:

a vat configured to contain solidifiable resin and having a release layer, the release layer being configured to transmit solidification energy from a solidification energy source into the vat of solidifiable resin to solidify at least a portion of the solidifiable resin in contact with the release layer; and

one or more release mechanisms including a vibration actuator connected to the release layer, wherein the apparatus is configured to vibrate the release layer using the vibration actuator to effect release of the solidifiable resin from the release layer.

The apparatus may be configured to vibrate the release layer at a sonic or ultrasonic frequency. Ultrasonic may be considered to relate to frequencies greater than 20 kHz. Sonic may be considered to relate to frequencies 20 Hz and 20 kHz

The apparatus may be configured to vibrate the release layer at a frequency between 30Hz to 70 kHz (or 80 kHz).

The apparatus may be configured to vibrate the release layer at a frequency between 30 Hz and 80 Hz.

The one or more release mechanisms may comprise a build plate configured to control the position of the object being printed with respect to the release layer;

wherein the apparatus comprises a force sensor configured to measure the force applied to the build plate as it is moving away from the release layer to release the object being printed; and

wherein the apparatus is configured to control the one or more release mechanisms based on the measured force.

The apparatus may comprise multiple vibration actuators.

The apparatus may comprise multiple vibration actuators and wherein the apparatus is configured to adjust the vibration frequency and phase of different vibration to produce different vibration patterns.

According to a further aspect, there is provided a method for controlling the release of an object being printed from a 3D printer, the method comprising:

curing a layer of resin between an object being printed and a release layer, the release layer being configured to transmit solidification energy from a solidification energy source into the vat of solidifiable resin to solidify at least a portion of the solidifiable resin in contact with the release layer;

vibrating the release layer to effect release of the solidifiable resin from the release layer.

The release assembly apparatus may form part of a 3D printer. The printer may comprise a two-dimensional light source (e.g. an LCD). The light source may comprise pixels which can be selectively turned on and off to cure a layer of the three-dimensional object. The layer will have a particular two-dimensional shape.

The release assembly apparatus may comprise a control system or controller. The control system may comprise a processor and memory. The memory may store computer program code. The processor may comprise, for example, a central processing unit, a microprocessor, an application-specific integrated circuit or ASIC or a multicore processor. The memory may comprise, for example, flash memory, a hard-drive, volatile memory. The computer program may be stored on a non-transitory medium such as a CD. The computer program may be configured, when run on a computer, to implement methods and processes disclosed herein.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a-1c is a series of front cross-sectional views of an embodiment of a 3D printer showing how a layer is added to a 3D object being printed.

FIG. 2 is a flow chart showing how the embodiment of FIG. 1a is used to print an object.

FIG. 3a is a front cross-sectional view of a further embodiment of a 3D printer.

FIG. 3b is a perspective view of the vat and vibration actuators of the 3D printer of FIG. 3a.

FIG. 4 is a flow chart showing how the embodiment of FIG. 3a is used to print an object.

FIGS. 5a-5c are experimental results.

### DETAILED DESCRIPTION

With reference to the figures, apparatus and methods are described which facilitate the release of a 3D printed object from a release layer within a vat of resin.

All terms have definitions that are reasonably inferable from the drawings and description.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

### First Embodiment: Build-Plate Separation

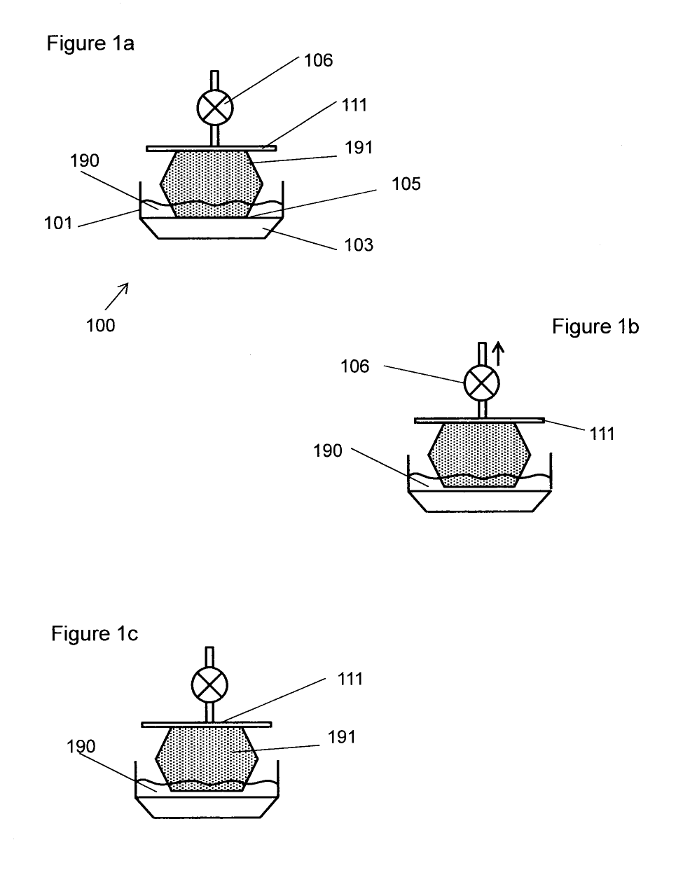

FIG. 1a shows an embodiment of a 3D printer comprising a release assembly. In particular, the release assembly comprises:

a vat 101 configured to contain solidifiable resin 190 and having a release layer 105, the release layer 105 being configured to transmit solidification energy from a solidification energy source 103 into the vat of solidifiable resin to solidify at least a portion of the solidifiable resin in contact with the release layer;

one or more release mechanisms including a build plate 111 configured to control the position of the object 191 being printed with respect to the release layer;

a force sensor 106 configured to measure the force applied to the build plate as it is moving away from the release layer to release the object being printed;

wherein the apparatus is configured to control the one or more release mechanisms based on the measured force.

In this case, the release layer 105 is the base of the vat 101.

In this case the release mechanism comprises moving the build plate away from the release layer to apply an extension force on the object being printed. The elasticity and/or rigidity of the printed material will cause separation of the object from the release layer.

In particular, FIG. 1a shows this situation when a layer of the resin has been cured onto a previously cured object 191 which is in the process of being printed.

In order to continue (or complete) printing, the newly solidified layer needs to be detached from the vat base. To do this, as shown in FIG. 1b, the build plate is raised along an axis of translation away from the bottom of the vat and the solidification source. As the build plate is raised the force sensor 106 is configured to monitor the force applied to the object by the build plate. In this case, the build plate 111 is configured to move at least the thickness of one printed layer away from release layer 105 at the bottom of the vat 101 (one printed layer may be between e.g. 0.05 mm to 0.15 mm thick). The uncured liquid resin 190 flows into the gap between the bottom of the printed object portion and the release layer.

Then the next layer of the object can be printed by selectively turning on pixels which cure portions of the liquid layer between the release layer and the printed object portion (as shown in FIG. 1c). This returns the apparatus to a situation similar to that of FIG. 1a (with an additional layer added). By iteratively curing, releasing and moving the build plate, the 3D object can be built up in layers.

The energy source in this case is an LCD screen which is configured to cure successive layers of the object being printed. Using a screen with pixels may allow the entire layer of be solidified simultaneously. Other light sources may include lasers, fluorescent lamps, gas-discharge lamps and incandescent lamps. Pixels may be provided by turning on and off particular light-sources within a light-source array and/or by blocking portions of light (e.g. using a liquid crystal assembly comprising a liquid crystal layer sandwiched between polarizers).

The energy source may comprise an LCD assembly being configured to emit UV light (e.g. between 375 and 395 nm or up to 420 nm). For example, the LCD assembly may comprise: a light source configured to emit light with a wavelength between 375-420 nm; first and second polarizers with a crossed polarization axes; and a liquid crystal layer positioned between the polarizers, wherein the LCD assembly is configured such that when light from the source is passed through the first and second polarizers and the LCD, the emitted light has a maximum spectral intensity between 375-420 nm.

In this case, the force sensor comprises load cells 106 attached to the build plate to measure the lifting force. The load cell is configured to relay information back to the printer (e.g. to a controller) to allow the printer (or controller) to adjust dynamically how the printer separates the part 191 from the release layer 105.

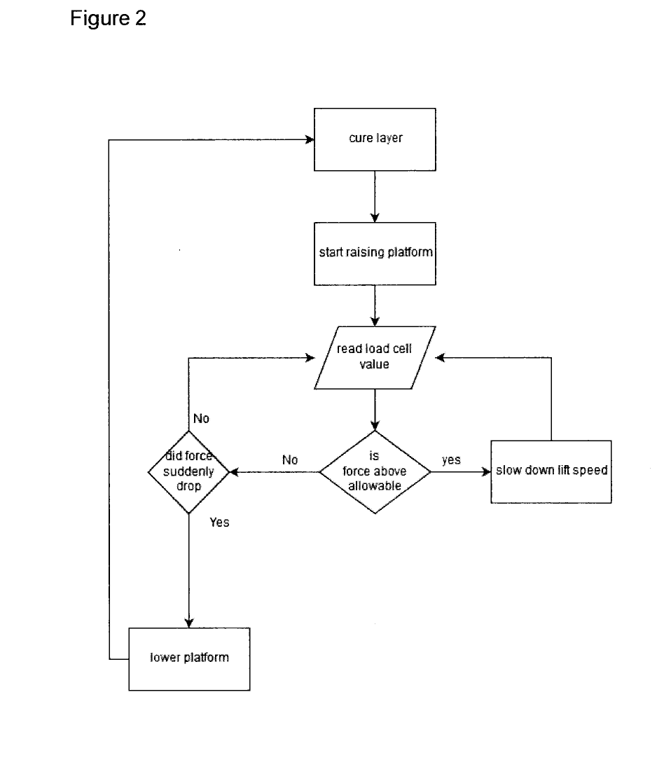

The method of operation of release mechanisms of the embodiment of FIG. 1a is shown in FIG. 2.

One mode of operation shown in FIG. 2 is that force sensor comprises one or more load cells 106. These load cells monitor the force applied to the printed object as the build plate is raised. Initially the measured force will rise as strain is put on the printed object as it is extended. When the newly-cured bottom layer begins to detach from the release layer, the strain will be released and the force on the build plate will decrease.

In this embodiment, the load cells are configured to detect a sudden drop in force when separating the printed object 191 from the release layer. The printer (or controller) in this case is configured to determine from the sudden drop in force when the object has successfully separated from the release layer (FIG. 1b). A load cell may be considered to be a transducer that is used to create an electrical signal whose magnitude corresponds (e.g. is directly proportional) to the force being measured. A load cell may comprise, for example, a hydraulic load cell, a pneumatic load cell and/or a strain-gauge load cell.

That is, in this case, the apparatus is configured to control the motion of the build plate with respect to the release layer based on the rate of change of the measured force. For example, the apparatus may be configured to stop separating the build plate from the release layer in response to detecting a decrease in measured force at a rate higher than a predetermined force-drop rate threshold. For example, the force-drop rate threshold may be dependent on the resin and print build area etc. The force-drop rate threshold may be 97% decrease in force per second. For example, if the force were measured in 0.1 second intervals, the threshold would be 9.7% per 0.1 second interval. Other thresholds may be used. For example, the force-drop rate threshold may be 80% decrease in force per second, or 50% decrease in force per second.

The absolute force may vary as the resting “weight” of the build-plate assembly changes due to buoyancy of the plate and the mass being attached to the plate. Instead the force sensor may be designed to detect rate of change in separation force. One setup may be designed to detect a drop of 90%/sec measured over 0.1 sec increments and sustain that for five increments. These values may change depending on the resin used and could be on the layer geometry. Thresholds may be absolute thresholds (e.g. a force threshold may be given in newtons) or relative thresholds (e.g. a force threshold may be given as a proportion of the maximum force measured during separation).

Other parameters may also be considered. For example, the apparatus may be configured to stop separating the build plate from the release layer in response to one or more of: detecting a decrease in measured force to below a release threshold value; and the separation distance between the release layer and the object being printed exceeding a predetermined threshold.

After release is detected, the apparatus may be configured to move directly to allow the next curing step to occur. This would allow the printer to only lift the amount required to peel each layer and quickly (e.g. instantly) start moving to the start position (for the next curing step). This may reduce the time between curing operations as significant time can be wasted in bottom down printing by lifting the printed object further than is required to effect separation.

In addition to adjusting the maximum lift height between curing operations (e.g. by stopping raising the build plate after release is detected), the apparatus may also dynamically adjust the lift speed. If the release force starts to reach a value were separation of the part 108 from the build plate 104 would be considered a possibility during the lifting (FIG. 1b) the load cell setup could tell the printer to slowdown the lifting mechanism allowing it to peel of easier from the vat and stay on the build plate. This would allow the printer to increase speed as the lift speed would only slowdown as much as needed to ensure that the part stays on the build plate.

The maximum allowable force may be predetermined based on the area of material cured in the first layer (i.e. the layer attached directly to the build plate). The maximum allowable force may also take into account the minimum area between two previously printed successive layers. For example, if printing a vertical hour-glass shape, it may be important to ensure that the object doesn't break at the narrowest or most fragile spot. Therefore, in such a case, the maximum allowable force may be reduced as the area of the printed layers decrease (and may not increase again as the printed layers increase again). The maximum allowable force may be predetermined based on the area of material cured in the last-cured layer (i.e. the layer attached directly to the release layer).

The method used to control the release mechanism is shown in FIG. 2. As shown in FIG. 2, after a layer is cured, the platform (or build plate) is raised. Then the force sensor (in this case the load cell connected to the build plate) is used to determine the load value. If the load value is above an allowable threshold, the speed of the build plate is reduced and the force sensor value is determined again. If the load value is below an allowable threshold and there has not been a sudden drop in force, the speed of the build platform is maintained and the force sensor value is determined again. When there is a sudden drop in measured force (load cell value) indicative of release of the cured layer, the build plate is moved such that the bottom of the object being printed is one-layer thickness away from the release layer. The thickness of a layer may be, for example, between 0.05 mm and 0.15 mm (or 0.001 mm and 0.5 mm). Then the curing process can restart. In this way, the object is built up layer by layer.

### Second Embodiment: Vibration-Assisted Separation

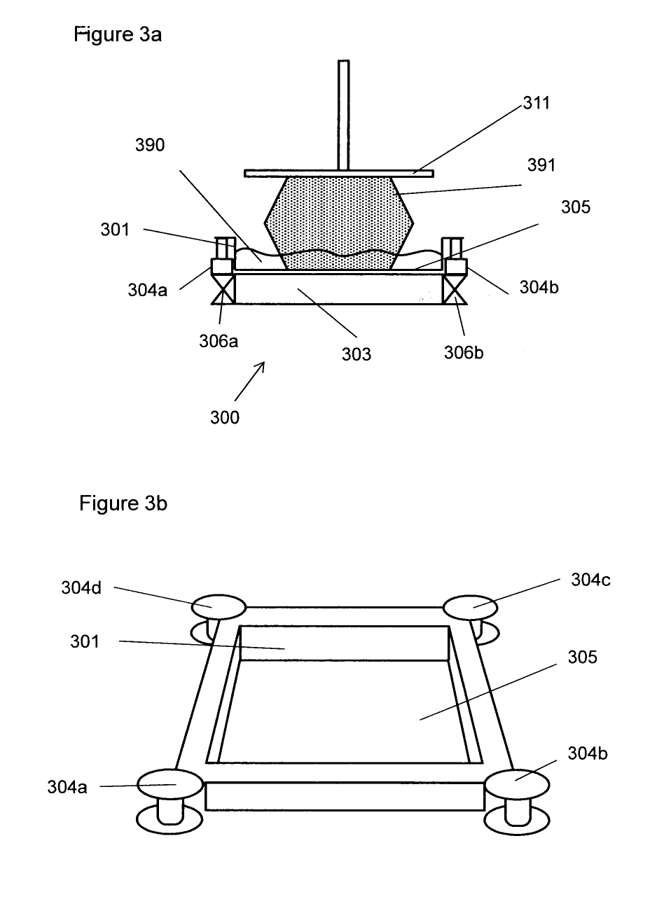

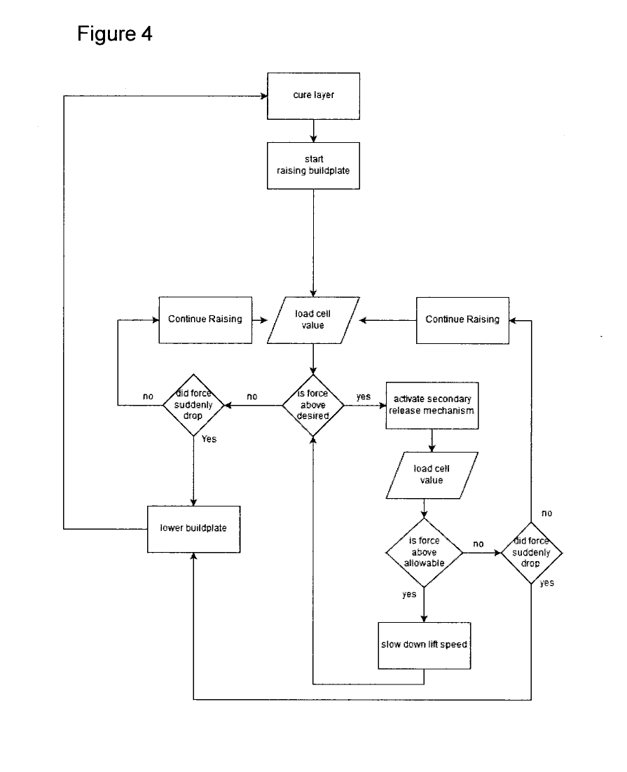

FIGS. 3a and 3b shows an embodiment of a 3D printer comprising a release assembly. In particular, the release assembly comprises:

a vat 301 configured to contain solidifiable resin 390 and having a release layer, the release layer 305 being configured to transmit solidification energy from a solidification energy source 303 into the vat of solidifiable resin to solidify at least a portion of the solidifiable resin in contact with the release layer;

a build plate 311 configured to control the position of the object 391 being printed with respect to the release layer;

a force sensor 306a,b configured to measure the force applied to the build plate as it is moving away from the release layer to release the object being printed;

wherein the apparatus is configured to control the one or more release mechanisms based on the measured force.

Unlike the previous embodiment, this 3D printer has two release mechanisms. In addition to being configured to move the build plate 311 away from the release layer 305 to apply an extension force on the object being printed, this embodiment comprises four vibration actuators 304a-d configured to vibrate the rigid release layer during separation. The vibration actuators, in this embodiment, are positioned at the four corners of the release layer 304a-d.

Another difference between this embodiment and the previous embodiment is that the force sensors are mounted between the release layer and the base. This may more accurately measure the force applied between the release layer and the cured layer.

The principles of printing by building up an object layer by layer are largely similar to that described for the embodiment of FIG. 1a.

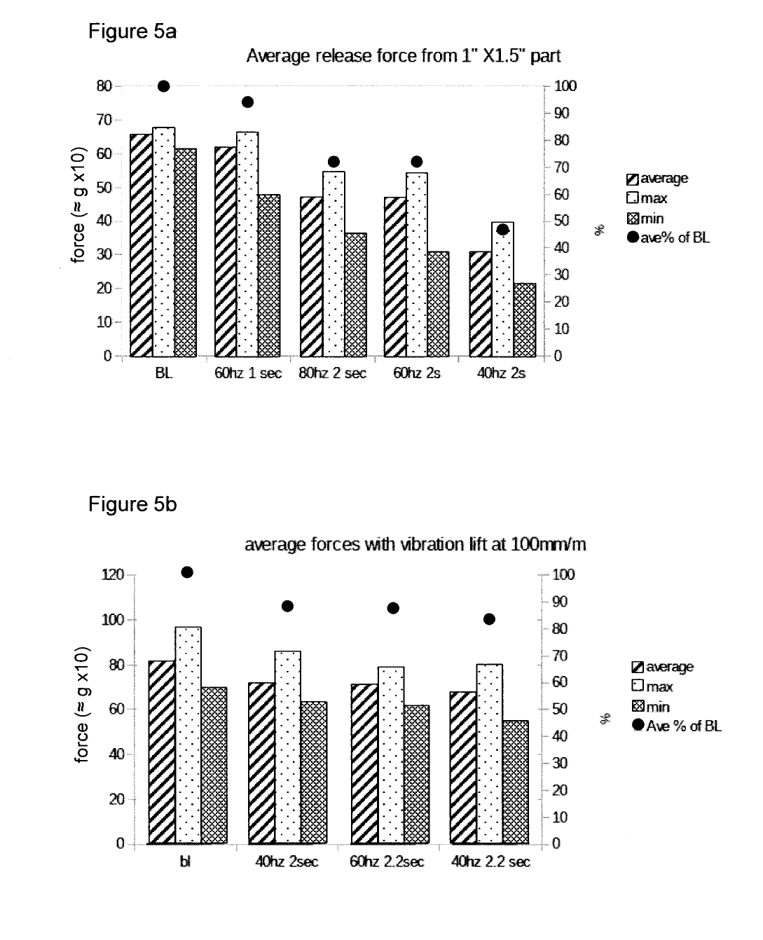

In this case, the two release mechanisms work together to release the cured layer from the release layer as shown in FIG. 4. After a layer has been cured, the build-plate is raised while the force being applied by the build plate to the release layer is measured by force sensors 306a,b. If the force is below a threshold value and a sudden drop has not been detected, the 3D printer is configured to continue raising the build plate.

If a sudden drop in pressure is detected, the apparatus 300 (e.g. a controller of the apparatus) is configured to determine that the cured layer has been released and stop raising the build plate and so return the object being printed to a position one-layer thickness away from the release layer to enable further curing to take place.

If however, the force is determined to exceed a predetermined threshold, the secondary vibration separation mechanism is activated. This causes the four vibration actuators to vibrate the release layer to effect separation of the cured layer from the release layer.

If the force remains above the threshold, the lift speed of the build plate is reduced. However, if the cured layer is released from the release layer this will be detected by a sudden drop of force which will prompt the printer to quickly position the build plate such that the object is one-layer thickness away from the release layer ready for the next curing step.

It will be appreciated that the apparatus may be configured to pause or stop vibration when a further force measurement is to be taken.

It will be appreciated that other embodiments may have one or more secondary release mechanisms (e.g. vibration-assisted separation) and have the force sensor connected to the build plate.

For printers with other forms of separation or separation assistance the system could determine when these are necessary. If the load cells reach a high enough value as its lifting (FIG. 4) then the system would turn on a release assist such as a vibration method 107 that would release the part. Other secondary release systems could consist of a stretching vat, a tilting vat, a sliding vat. It may also be possible to determine whether continuous printing is possible on printers capable of this and when a layered approach is necessary. This may extend the lifespan of the printer as the secondary release would only be used when needed.

### Vibration-Assisted Separation

The vibration release method utilizes tactical transducers 307 placed on the corners of a vat 301 to emit a vibration through the vat helping release the part from the curing surface at the bottom of the vat 302. The vibration may be most effective at if it is done just before the part is released from the vat. The vibration being used can be varied (e.g. using a controller) from 31 Hz to 65535 Hz via the transducers. In experiments described below, it has been found that frequencies of between 31 Hz and 80 Hz have been most effective with the best results at around 40 Hz. The amplitude of the vibration may be less than a printed-layer thickness (e.g. 0.05 mm to 0.15 mm).

The vibration may also be applied to the release layer using one or more vibration transducers. The vibration may be applied to the vat as a whole. In embodiments with multiple vibration actuators (such as that described in relation to FIG. 3), the apparatus may be configured to adjust the phase and/or amplitude of the individual transducers to achieve particular effects.

For example, the phase and amplitude of the individual vibration actuators may be controlled to set up different normal modes of vibration within the release plate. This may allow the amplitude of vibration of one portion of the release plate to be larger than other regions of the release plate. This may help allow sensitive portions of the printed object to be protected by ensuring that weak spots experience a lower amplitude of vibration.

It will also be appreciated that if the force sensors determined that a particular region of the release plate was under greater tension through movement of the build plate (e.g. if in the embodiment of FIG. 3 the front left force sensor was giving a larger force reading than the rest), the individual vibration actuators may be configured to target that zone of the release plate (e.g. by vibrating the front left vibration actuator with a larger amplitude).

### Experimental Results—Vibration

Test 1

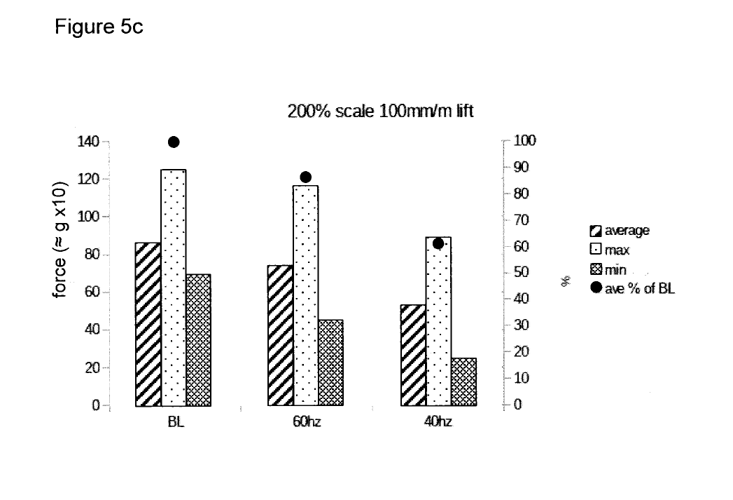

In this test a 1″ by 1.5″ part was printed for 15 layers at several different frequency and time periods with a baseline for reference (with no vibration) labelled baseline, BL. The results are shown in FIG. 5a. In FIGS. 5a (and 5b and 5c) the bars show three force values given in gram-force (1 gram-force=1 g×9.81 ms⁻²=0.00981N) associated with the left-hand ordinate axis: the left-hand bar in each triplet gives the average release force; the middle bar gives the maximum release force; and the right-hand bar gives the minimum release force. The dots show the comparative average release force as a percentage of the baseline average release force (associated with the right-hand ordinate axis).

From this significant release reduction with even the short 60 Hz vibration can be seen. Prolonging the vibration to be near the release causes an even more significant release reduction. It is also noted that the lowest release force was at 40 Hz at 2 seconds. This indicates that either:
low frequencies may be best for this type of release or
this frequency is the resonant frequency of the transducers.
   In any case, we found that the 40 Hz to be the most effective frequency for release less then 50% average release force.

### Test 2

In this test (results shown in FIG. 5b) the lifting speed was increased to twice (100 mm/min) that of the previous test (50 mm/min) to see if the part would still print properly. The material on the bottom of the vat was also changed to one previously determined to be better for release (FEP film).

From this test we see that the parts printed successfully. Because, in this test, the lift is much faster the release was close to the vibration period so the vibration duration was increased to 2.2 sec to make the vibration right at the point of release. This indicates that there is still a significant reduction of release force and the best vibration was still at 40 Hz. The release was relatively less effective than the slower lift though this could be due to new material not needing the effects of vibration as much. Nevertheless a significant drop in forces was demonstrated.

### Test 3

The test (results shown in FIG. 5c) was preformed again with twice the length and width (2″ by 3″) to determine how the effect might scale with larger parts. From this test we found that the release forces were more significant with a larger part having 60% the forces than the baseline in comparison to about 85% with the same settings but a smaller part. This indicates that the potential gains become more and more pronounced with objects with larger surface areas.

### CONCLUSION

In this test of the vibration release method the results indicate that vibration may provide an effective solution for reducing release forces. This method appears to be especially effective with large print areas.

Although the present invention has been described and illustrated with respect to preferred embodiments and preferred uses thereof, it is not to be so limited since modifications and changes can be made therein which are within the full, intended scope of the invention as understood by those skilled in the art.

1. A release assembly apparatus for a 3D printer, the apparatus comprising:
a vat configured to contain solidifiable resin and having a release layer, the release layer being configured to transmit solidification energy from a solidification energy source into the vat of solidifiable resin to solidify at least a portion of the solidifiable resin in contact with the release layer;
one or more release mechanisms including a build plate configured to control the position of the object being printed with respect to the release layer;
a force sensor configured to measure the force applied to the object being printed as it is moving with respect to the release layer to release the object being printed;
wherein the apparatus is configured to control the one or more release mechanisms based on the measured force.

2. The apparatus of claim 1, wherein the apparatus is configured to control the motion of the build plate with respect to the release layer based on the measured force.

3. The apparatus of claim 1, wherein the apparatus is configured to control the motion of the build plate with respect to the release layer based on absolute value of the measured force.

4. The apparatus of claim 1, wherein the apparatus is configured to slow down separation speed if the force is above a separation-speed threshold force value.

5. The apparatus of claim 1, wherein the apparatus is configured to increase separation speed if the force is below a low threshold value.

6. The apparatus of claim 1, wherein the apparatus is configured to control the motion of the build plate with respect to the release layer based on the rate of change of the measured force.

7. The apparatus of claim 1, wherein the apparatus is configured to stop separating the build plate from the release layer in response to detecting a decrease in measured force at a rate higher than a predetermined force-drop rate threshold.

8. The apparatus of claim 1, wherein the apparatus is configured to stop separating the build plate from the release layer in response to detecting a decrease in measured force to below a release threshold value.

9. The apparatus of claim 1, wherein the apparatus is configured to control a secondary release mechanism based on the measured force.

10. The apparatus of claim 1, wherein the apparatus is configured to initiate the secondary release mechanism in response to measuring a force above a secondary-release threshold force value.

11. The apparatus of claim 1, wherein the apparatus is configured to control the one or more release mechanisms based on the measured force and the area cured in the last curing step.

12. The apparatus of claim 1, wherein the apparatus is configured to control the one or more release mechanisms based on the measured force and the shape of the last printed layer.

13. The apparatus of claim 1, wherein the one or more release mechanisms includes a vibration actuator connected to the release layer, wherein the apparatus is configured to vibrate the release layer using the vibration actuator to effect release of the solidifiable resin from the release layer.

14. A method for controlling the release of an object being printed from a 3D printer, the method comprising:
curing a layer of resin between an object being printed and a release layer, the release layer being configured to transmit solidification energy from a solidification energy source into the vat of solidifiable resin to solidify at least a portion of the solidifiable resin in contact with the release layer;
moving the object with respect to the release layer to release the object being printed;
measuring the force applied to the object being printed as it is moving with respect to the release layer;
controlling one or more release mechanisms based on the measured force.

15. A release assembly apparatus for a 3D printer, comprising:
a vat configured to contain solidifiable resin and having a release layer, the release layer being configured to transmit solidification energy from a solidification energy source into the vat of solidifiable resin to solidify at least a portion of the solidifiable resin in contact with the release layer; and
one or more release mechanisms including a vibration actuator connected to the release layer, wherein the apparatus is configured to vibrate the release layer using the vibration actuator to effect release of the solidifiable resin from the release layer.

16. The apparatus of claim 15, wherein the apparatus is configured to vibrate the release layer at a sonic or ultrasonic frequency.

17. The apparatus of claim 15, wherein the apparatus is configured to vibrate the release layer at a frequency between 30Hz to 80 Hz.

18. The apparatus of claim 15, wherein the one or more release mechanisms comprise a build plate configured to control the position of the object being printed with respect to the release layer;
wherein the apparatus comprises a force sensor configured to measure the force applied to the build plate as it is moving away from the release layer to release the object being printed; and
wherein the apparatus is configured to control the one or more release mechanisms based on the measured force.

19. The apparatus of claim 15, wherein the apparatus comprises multiple vibration actuators and wherein the apparatus is configured to adjust the vibration frequency and phase of different vibration to produce different vibration patterns.

20. A method for controlling the release of an object being printed from a 3D printer, the method comprising:
curing a layer of resin between an object being printed and a release layer, the release layer being configured to transmit solidification energy from a solidification energy source into the vat of solidifiable resin to solidify at least a portion of the solidifiable resin in contact with the release layer;
vibrating the release layer to effect release of the solidifiable resin from the release layer.
